(19) United States
(12) Patent Application Publication
(10) Pub. No.: US 2025/0086488 A1
(43) Pub. Date: Mar. 13, 2025

(54) BRIDGE MONITORING METHOD, SYSTEM, A STRUCTURE STATE MONITORING DEVICE AND A STORAGE MEDIUM

(71) Applicant: WSGRI ENGINEERING & SURVEYING INCORPORATION LIMITED, WUHAN (CN)

(72) Inventors: ZHONGHAI ZANG, WUHAN (CN); HAIFENG LI, WUHAN (CN); YANGDONG PENG, WUHAN (CN); SEN CHEN, WUHAN (CN); HAO WU, WUHAN (CN); KE YANG, WUHAN (CN); SHUQIANG GUI, WUHAN (CN)

(21) Appl. No.: 18/510,670

(22) Filed: Nov. 16, 2023

Related U.S. Application Data
(63) Continuation of application No. PCT/CN2023/118967, filed on Sep. 15, 2023.

(30) Foreign Application Priority Data
Sep. 8, 2023 (CN) 202311168835.3

(51) Int. Cl. G06N 10/40; G06N 10/20; G06Q 10/20

(52) U.S. Cl. CPC G06N 10/40; G06N 10/20; G06Q 10/20

(57) ABSTRACT

A bridge monitoring method, system, a structure state monitoring device and a storage medium, which comprises: obtaining at least one qubit pair in a quantum entangled state; the coupling relationship between the qubit pair state of at least one qubit pair and the physical parameters of the bridge is constructed. The qubit pair state of at least one qubit pair is monitored, and the structural state of the bridge is determined based on the qubit pair state and the coupling relationship. The invention uses the entanglement relation of quantum bits to realize the real-time monitoring of the bridge structure state in the full range of the bridge with high sensitivity and high resolution.

### FIELD OF THE DISCLOSURE

The disclosure relates to bridge safety, and particularly to a bridge monitoring method, system, a structure state monitoring device and a storage medium.

### BACKGROUND

As an important part of infrastructure, bridge plays a key role in modern society. However, with the gradual extension of the service life of bridges, the health monitoring and damage detection of bridge structures become particularly important. Traditional bridge monitoring methods usually use sensors to measure stress, displacement, vibration and other parameters, and then through data analysis to assess the health of the bridge structure.

However, there are some limitations and challenges in the traditional methods: (1) the traditional sensors can only measure the physical parameters of the local location, but can not realize the overall monitoring of the whole bridge structure; (2) the traditional method is disturbed by noise and environmental factors, which results in limited sensitivity and precision of measurement, especially for the monitoring of micro-structural changes; (3) it is difficult to monitor the bridge health status in real time because the traditional methods need to collect data offline and carry out complex analysis.

Therefore, it is urgent to put forward a bridge monitoring method, system, a structure state monitoring device and a storage medium to solve the above technical problems.

### SUMMARY

In view of above, it is necessary to provide a bridge monitoring method, system, a structure state monitoring device and a storage medium to solve the technical problems existing in the existing technology, such as the inability to realize the global bridge monitoring, the low monitoring sensitivity and the inability to carry out the real-time monitoring of the bridge.

In one aspect, the invention provides a bridge monitoring method, comprising:
obtaining at least one qubit pair in the quantum entangled state;
constructing a coupling relationship between the qubit pair state of at least one qubit pair and the physical parameters of the bridge;
monitoring the qubit pair state of at least one qubit pair, and the structural state of the bridge is determined based on the qubit pair state and the coupling relationship.

In some possible implementations, obtaining at least one qubit pair in the quantum entangled state, comprising:
obtaining at least two initial qubits, the quantum gate operation is performed on the at least two initial qubits to obtain the at least one qubit pair in the quantum entanglement state.

In some possible implementations, at least two initial qubits comprise at least one initial qubit pair, and the quantum gate operation comprises controlled non-gate operation and hadamard gate operation; the quantum gate operation is performed on the at least two initial qubits to obtain the at least one qubit pair in the quantum entanglement state, comprising:
controlled non-gate operation is performed on the initial qubit pair to obtain an associated qubit pair, which comprises a first associated qubit and a second associated qubit.
hadamard gate operation is performed on the first associated qubit or the second associated qubit to obtain at least one qubit pair in a quantum entangled state.

In some possible implementations, the qubit pair comprises a first qubit and a second qubit; after obtaining at least one qubit pair in the quantum entangled state, comprising:
the correlation between the first qubit and the second qubit is measured, and the existence of the quantum entangled state is confirmed based on the correlation, when the quantum entangled state does not exist, the quantum gate operation is re-performed on the qubit pair.

In some possible implementations, comprising:
obtaining the reference structure state of the bridge, and determining whether the coupling relationship needs to be adjusted based on the reference structure state and the structure state;
when the coupling relationship needs to be adjusted, the qubit parameters of the qubit, and/or the positional parameters of the qubit are adjusted to obtain the optimization parameters, and the optimized coupling relationship is obtained according to the optimization parameters.

In some possible implementations, the qubit pair comprises a first qubit and a second qubit; the qubit pair state comprises the first qubit, and/or the quantum state of the second qubit and the quantum entangled state of the qubit pair, the coupling relation comprises a first coupling relation between the quantum state and the physical parameters of the bridge and a second coupling relation between the quantum entangled state and the physical parameters of the bridge; the qubit pair state of at least one qubit pair is monitored, comprising:
monitoring the quantum state of the first qubit and/or the second qubit and determine the structural state of the bridge based on the quantum state and the first coupling relationship;
and/or,
monitoring the quantum entangled state, and the structural state of the bridge is determined based on the quantum entangled state and the second coupling relation.

In some possible implementations, comprising:
obtaining the temporal and positional characteristics of the structural state;
the visualization template is determined based on the time feature and the position feature, and the structure state is visually displayed based on the visualization template.

In another aspect, the invention provides a bridge monitoring system, comprising:
the qubit pair acquisition unit, is used to obtain at least one qubit pair in the quantum entangled state;
the coupling relationship building unit is used to construct a coupling relationship between the qubit pair state of at least one qubit pair and the physical parameters of the bridge;
the bridge monitoring unit is used to monitor the qubit pair state of at least one qubit pair, and the structural state of the bridge is determined based on the qubit pair state and the coupling relationship.

In another aspect, the invention provides a structure state monitoring device, comprising memory and processor, among which,
the memory is used to store a program;
the processor, coupled with the memory, is used to execute the program stored in the memory to implement the steps in the bridge monitoring method described in any of the possible implementations.

In another aspect, the invention provides a computer-readable storage medium is used to store a computer-readable program or instruction that, when executed by the processor, is capable of fulfilling the steps in the bridge monitoring method described in any of the possible implementations.

The beneficial effects of the above implementation are: the bridge monitoring method firstly obtains at least one qubit pair in the quantum entangled state, and then realizes the monitoring of the bridge structure state based on at least one qubit pair. The special correlation of the quantum entangled state makes the state change of one qubit immediately affect the state of the other qubit, which is not affected by distance. Therefore, It can realize the monitoring of the whole range of Bridges and Bridges with large spans, and the monitoring results are more comprehensive. Further, the invention utilizes the non-classical properties of qubits to capture small structural changes and realize high sensitivity monitoring of Bridges. Further, because the qubit pair state of the qubit pair can be obtained in real time, that is, real-time monitoring of the bridge can be realized.

### BRIEF DESCRIPTION OF THE FIGURES

Many aspects of the present implementation can be better understood with reference to the following figures. The components in the drawings are not necessarily drawn to scale, the emphasis instead being placed upon clearly illustrating the principles of the present implementation. Moreover, in the drawings, all the views are schematic, and like reference numerals designate corresponding parts throughout the several views.

FIG. 1 is a schematic diagram of an implementation of a bridge monitoring method.

FIG. 2 is a schematic diagram of an implementation process for preparing a qubit pair.

FIG. 3 is a schematic diagram of an implementation flow for optimizing coupling relations.

FIG. 4 provides a schematic diagram of an implementation flow diagram for visualizing a structural state.

FIG. 5 provides a schematic diagram of an implementation flow of generating alarm information.

FIG. 6 is a schematic diagram of an implementation process for maintaining an abnormal bridge.

FIG. 7 is a schematic diagram of an implementation of a bridge monitoring system.

FIG. 8 is a schematic diagram of an implementation of a structural condition monitoring device.

### DETAILED DESCRIPTION

The following is a clear and complete description of the technical scheme in the implementation of the invention in combination with the figures in the implementation of the invention. Obviously, the implementations described are only partial implementations of the invention and not all implementations. Based on the implementations of the invention, all other implementations obtained by a person skilled in the art without creative labor fall within the scope of protection of the invention.

It should be understood that the schematic figures are not drawn to physical scale. The process diagram used in the invention shows the operation realized according to some implementations of the invention. It should be understood that flowchart operations can be implemented out of sequence, and steps without logical context can be reversed or implemented simultaneously. In addition, a person skilled in the art may, guided by the contents of the present invention, add one or more other operations to the flow chart or remove one or more operations from the flow chart.

“And/or” describes the association relationship of the associated object, indicating that there are three kinds of relationships, for example, A and/or B, which can be: A exists alone, A and B exist simultaneously, or B exists alone.

References to “implementations” herein imply that specific features, structures or properties described in conjunction with implementations may be included in at least one implementation of the present invention. The presence of the phrase at various points in the specification does not necessarily refer to the same implementation, nor is it a separate or alternative implementation that is mutually exclusive with other implementations. It is understood explicitly and implicitly by those skilled in the art that implementations described herein may be combined with other implementations.

FIG. 1 is a schematic diagram of an implementation of a bridge monitoring method, as shown in FIG. 1. The bridge monitoring method comprises: S101, obtaining at least one qubit pair in the quantum entangled state; S102, constructing a coupling relationship between the qubit pair state of at least one qubit pair and the physical parameters of the bridge;

S103, monitoring the qubit pair state of at least one qubit pair, and the structural state of the bridge is determined based on the qubit pair state and the coupling relationship.

The beneficial effects of the above implementation are: the bridge monitoring method firstly obtains at least one qubit pair in the quantum entangled state, and then realizes the monitoring of the bridge structure state based on at least one qubit pair. The special correlation of the quantum entangled state makes the state change of one qubit immediately affect the state of the other qubit, which is not affected by distance. Therefore, it can realize the monitoring of the whole range of Bridges and Bridges with large spans, and the monitoring results are more comprehensive. Further, the invention utilizes the non-classical properties of qubits to capture small structural changes and realize high sensitivity monitoring of Bridges. Further, because the qubit pair state of the qubit pair can be obtained in real time, that is, real-time monitoring of the bridge can be realized.

It should be noted that the bridge monitoring method proposed in the implementation of the invention can also be applied to monitoring the structural state of highway, tunnel and other structures.

In specific implementations of the invention, the coupling relationship of step S102 may be the relationship between the energy splitting of qubits and physical parameters such as bridge stress, bridge temperature, and bridge vibration. It can also be the relationship between qubit transition frequency and physical parameters such as bridge stress, bridge temperature and bridge vibration. That is to say, by measuring the energy splitting or transition frequency of qubits, physical changes such as the stress of the bridge can be determined through the coupling relationship, and the status of the bridge structure can be monitored.

In order to realize real-time monitoring of the structural state of the bridge, the specific way to monitor the qubit state of at least one qubit pair in step S103 is as follows: a special quantum measurement device is equipped for real-time monitoring of qubits. The quantum measurement device should have the characteristics of high precision and high speed to capture the change of qubit state.

After obtaining the qubit pair, the qubit pair needs to be fixed to the bridge to realize the monitoring of the structural state of the bridge. Specifically, at least one qubit is fixed to the target installation position of the bridge by means of a sensor, which can be either a superconducting coil or a micro-nano mechanical structure.

To be clear: because qubits are sensitive to external noise and environmental influences, in order to avoid the influence of external noise and environment on the monitoring results, in some implementations of the invention, when at least one qubit is fixed to the bridge, superconducting encapsulation, vacuum chamber, etc., is used to package the bridge to reduce external interference and further improve the accuracy of the determined structural state of the bridge.

Since the qubit pair in the implementation of the invention is installed in a part of the bridge, that is, the position of the installed qubit pair is monitored to represent the structural state of the entire bridge, thus the rationality of the selection of the installation position is closely related to the accuracy of the monitoring of the structural state of the bridge, and the installation position should be determined according to the design and structural characteristics of the bridge.

In the implementation of the invention, the installation position may be the key node of the bridge, the support, the beam-column connection, etc.

In some implementations of the invention, step S101 is specifically: obtaining at least two initial qubits, the quantum gate operation is performed on the at least two initial qubits to obtain the at least one qubit pair in the quantum entanglement state.

It should be noted that in order to improve the reliability of the monitored bridge structural state, the initial qubit should be a qubit with stable quantum performance. Specifically, the initial qubit should be any of the superconducting qubits and ion trap qubits.

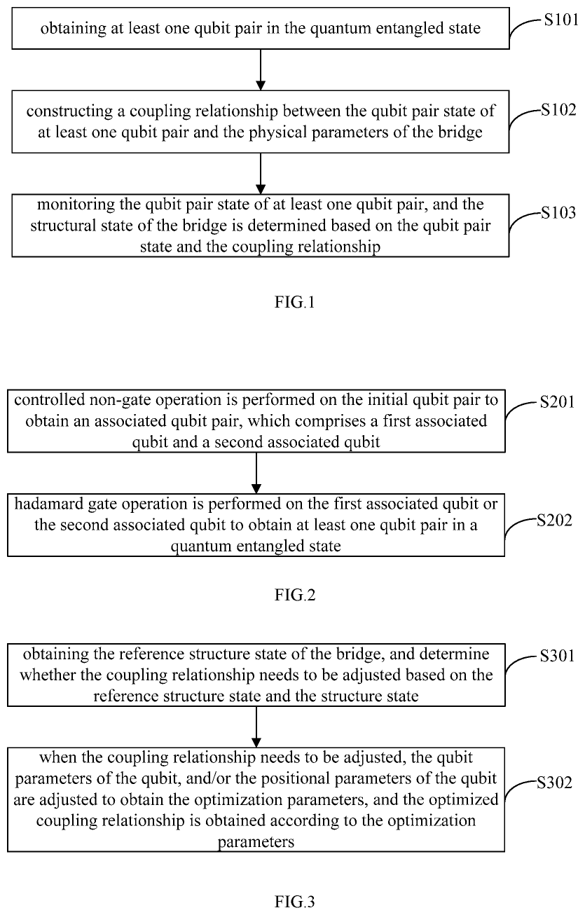

In some implementations of the invention, at least two initial qubits comprise at least one initial qubit pair, and the quantum gate operation comprises controlled non-gate operation and hadamard gate operation; as shown in FIG. 2, the quantum gate operation is performed on the at least two initial qubits to obtain the at least one qubit pair in the quantum entanglement state, comprising:
S201, controlled non-gate operation is performed on the initial qubit pair to obtain an associated qubit pair, which comprises a first associated qubit and a second associated qubit;
S202, hadamard gate operation is performed on the first associated qubit or the second associated qubit to obtain at least one qubit pair in a quantum entangled state.

The expression for the controlled non-gate in step S201 is:

$$CNOT = \vert 0 〉 〈 0 \vert ⊗ I + \vert 1 〉 〈 1 \vert ⊗ X$$

where, |0 [symbol] is the first initial qubit in the ground state; [symbol] 0| is the second initial qubit in the ground state; ⊗ is the symbol of the Kronecker product operation; I is the identity matrix; |1 [symbol] is the first initial qubit in the excited state; [symbol] 1| is the second initial qubit in the excited state; X is the Pauli X matrix, that is, the quantum non-gate matrix.

The purpose of the hadamard gate operation in step S202 is to bring the first associated qubit or the second associated qubit from the ground state into the average state in order to make it entangled with other qubits.

Specifically, taking the average state of the first associated qubit as an example, the expression of the average state |+ [symbol] is:

$$\vert + 〉 = ( \vert 0 〉 + \vert 1 〉 ) / √ 2$$

It should be noted that the method of controlling whether the first initial qubit and the second initial qubit are in the ground state or the excited state can be as follows: by applying several light pulses to the first initial qubit and the second initial qubit in the excited state, the first initial qubit and the second initial qubit are controlled to be in the ground state.

In monitoring the bridge, the particularity of the quantum entangled state between the quantum bit pairs is utilized, that is, the stronger the correlation of the quantum entangled state, the more accurate the monitoring result will be. Therefore, in the specific implementation of the invention, the quantum entangled state between the quantum bit pairs is the Bell state.

In order to ensure that the quantum entangled state of the obtained qubit pair actually exists to ensure the feasibility of monitoring the bridge, in some implementations of the invention, after step S101, comprising:
the correlation between the first qubit and the second qubit is measured, and the existence of the quantum entangled state is confirmed based on the correlation, when the quantum entangled state does not exist, the quantum gate operation is re-performed on the qubit pair.

By confirming whether the quantum entangled state of the obtained qubit pair exists, the implementation of the invention can ensure that the generated qubit pair exists quantum entanglement, thus ensuring the feasibility and accuracy of monitoring the bridge through the qubit pair.

Among them, measuring the correlation between the first qubit and the second qubit can be specifically: measuring the Bell inequality or the density matrix of the first qubit and the second qubit, so as to know the correlation.

Due to the influence of quantum noise and installation error, the coupling relationship between the constructed qubit pair state and the physical parameters of the bridge may be inaccurate. In order to solve this technical problem, in some implementations of the invention, as shown in FIG. 3, bridge monitoring methods comprising:
S301, obtaining the reference structure state of the bridge, and determine whether the coupling relationship needs to be adjusted based on the reference structure state and the structure state;
S302, when the coupling relationship needs to be adjusted, the qubit parameters of the qubit, and/or the positional parameters of the qubit are adjusted to obtain the optimization parameters, then optimized coupling relationship is obtained according to the optimization parameters.

By optimizing the coupling relationship according to the reference structure state and structure state, the implementation of the invention can obtain the optimized coupling relationship and ensure the accuracy of the coupling relationship, thus improving the accuracy of the structure state determined by the coupling relationship, that is, improving the accuracy of the bridge monitoring method and realizing high-precision monitoring.

Among them, the reference structure state can be the structure state with reference significance determined by simulation or multiple experiments.

It should be noted that qubit parameters include quantum gate operation parameters, initialization parameters, etc. The positional parameter of the qubit refers to the position of the qubit installed on the bridge.

In some implementations of the invention, the qubit pair state includes the first qubit, and/or the quantum state of the second qubit and the quantum entangled state of the qubit pair, and the coupling relation includes the first coupling relation between the quantum state and the physical parameters of the bridge, and the second coupling relation between the quantum entangled state and the physical parameters of the bridge; the qubit pair state of at least one qubit pair is monitored in step S103, comprising:
monitoring the quantum state of the first qubit and/or the second qubit and determine the structural state of the bridge based on the quantum state and the first coupling relationship;
and/or,
monitoring the quantum entangled state, and the structural state of the bridge is determined based on the quantum entangled state and the second coupling relation.

It should be noted that monitoring the quantum entangled state of a qubit pair can be specifically monitoring the quantum state density matrix of a qubit pair.

The implementation of the invention, proposes to determine the structural state of the bridge by monitoring the quantum state of the qubit, and/or monitoring the quantum entangled state of the qubit pair, and realize the diversity of the way of determining the structural state of the bridge. In addition, the potential problems in the bridge structure can be identified through the structure of the two ways, and the reliability and accuracy of the bridge condition monitoring can be improved. Further, the combination of quantum state and quantum entangled state to determine the structural state of the bridge can achieve high sensitivity and high resolution monitoring of the bridge structure, thus providing key information for the maintenance and repair of the bridge and ensuring the safety of the bridge.

It should be understood that before the monitoring begins, a baseline measurement is made to record the initial state of the qubit. This can be used as a reference point to compare subsequent measurements. Specifically, the qubit state measured in real time is compared with the benchmark measurement results. By comparing the change of qubit state, the change of bridge structure, such as stress distribution and damage location, can be analyzed.

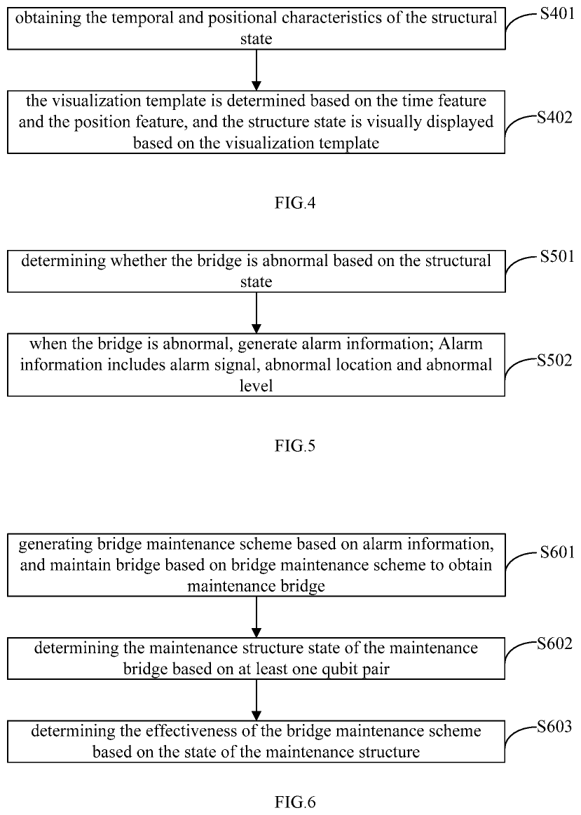

In order to more intuitively see the structural state of the bridge, in some implementations of the invention, as shown in FIG. 4, the bridge monitoring method comprising:
S401, obtaining the temporal and positional characteristics of the structural state;
S402, the visualization template is determined based on the time feature and the position feature, and the structure state is visually displayed based on the visualization template.

The implementation of the invention determines the visual template by obtaining the time characteristics and position characteristics of the structural state, and can improve the fit degree of the visual template and the structural state data, so as to improve the intuitiveness of the visual display of the structural state. Further, visualization transforms abstract data into intuitive images, making it easier to capture patterns, trends, and anomalies in the data. Through visualization, we can better understand how the bridge structure is changing, discover anomalies and trends, and then make appropriate decisions to guide maintenance and restoration efforts.

In the specific implementation of the invention, the time sequence of structural state changes can be determined according to the time characteristics, and the bridge structure data can be presented in a visual way based on the visualization template in the form of graphs, line drawings, etc., to help the staff observe the trend and periodic changes of the bridge structure data; When the number and scale of time and location features are large, the data distribution and changes of structural state data are displayed based on visual templates such as thermal maps, so as to discover the changes in space and time. You can also create a dynamic presentation, a visual template, to show the change of data over time, which can help to observe the evolution of structural changes and find instantaneous changes and trends. Visual templates such as scatter plots and scatter matrices can also be used to show relationships and correlations between multidimensional data to reveal underlying structural information. If the bridge involves multiple Geographic locations, the results of the data can be displayed on a map using Geographic Information System (GIS) technology to gain spatial insight.

It should be noted that for ease of viewing, interactive visualization tools can also be created, allowing users to freely explore the data, zoom in and out, and select parts of interest.

To ensure the safety of the bridge, in some implementations of the invention, as shown in FIG. 5, the bridge monitoring method also includes: S501, determining whether the bridge is abnormal based on the structural state; S502, when the bridge is abnormal, generate alarm information; Alarm information includes alarm signal, abnormal location and abnormal level.

The implementation of the invention quickly generates alarm information when the abnormal situation of the bridge is detected, and the alarm signal in the alarm information can be used by the operator or maintenance personnel to know the abnormal bridge in the first time, so as to ensure that the bridge structure can be threatened and the safety of the bridge can be maintained quickly.

Further, through the occurrence location of the alarm information, the maintenance personnel can accurately know the abnormal occurrence location, so that the maintenance personnel can quickly reach the abnormal occurrence location, and improve the maintenance and repair efficiency.

Further, through the abnormal level in the alarm information, guidance can be provided for the subsequent maintenance and repair of the bridge, and the efficiency of maintenance and repair can be improved.

Among them, the alarm signal can be an audible and visual alarm signal.

It should be noted that anomaly levels include, but are not limited to, mild, moderate, and severe anomalies. The minor anomaly can be a slight deformation of the bridge structure, the moderate anomaly can be a concave bridge, and the serious anomaly can be a dislocation or fracture of the bridge.

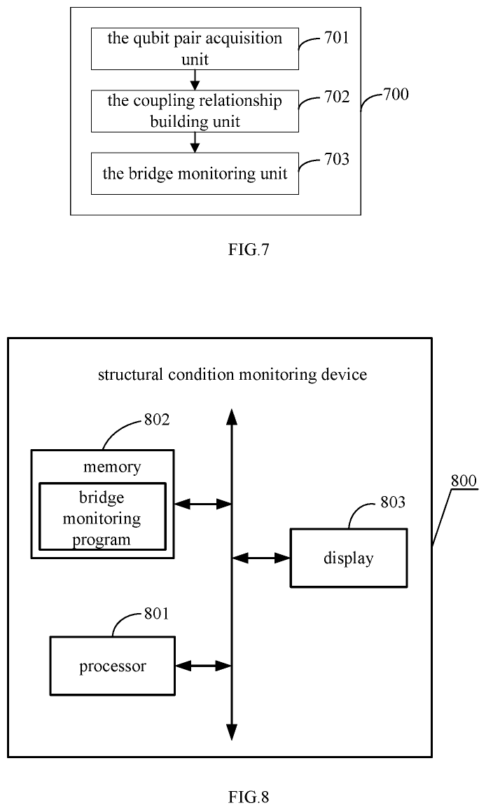

In order to ensure that the normal use of the bridge is not affected after an anomaly occurs, in some implementations of the invention, as shown in FIG. 6, the bridge monitoring method comprising:
S601, generating bridge maintenance scheme based on alarm information, and maintain bridge based on bridge maintenance scheme to obtain maintenance bridge;
S602, determining the maintenance structure state of the maintenance bridge based on at least one qubit pair;
S603, determining the effectiveness of the bridge maintenance scheme based on the state of the maintenance structure.

The implementation of the invention generates a bridge maintenance plan based on the alarm information, without the need for maintenance personnel to manually formulate a maintenance plan, and improves the maintenance efficiency. After the maintenance is completed, the state of the qubit will be monitored again. By comparing the monitoring results before and after the maintenance, it can confirm whether the structure has returned to normal and the effectiveness of the maintenance measures.

It should be noted that the bridge maintenance plan will involve temporary reinforcement, repair or other maintenance methods according to the different abnormal levels.

High-quality data is the basis of data processing and analysis, and any distortion or loss of data may affect the final monitoring results. By ensuring the accuracy, real-time and security of qubit state data, it can provide a reliable data source for the subsequent determination of bridge structural state, so as to realize the in-depth understanding and analysis of bridge structural changes.

Therefore, in some implementations of the invention, after monitoring the qubit pair state of at least one qubit pair in step S104, it comprising: the state data of qubit against state are denoised, interpolated and normalized successively.

The implementation of the invention can remove noise and outliers and make the data more analytical by successively de-noising, interpolating and normalizing the state data of the qubit to the state. The missing value in the state data can be filled by interpolation to maintain the continuity and consistency of the data. The comparability between different feature data can be made by normalization processing. Ensure the accuracy and validity of subsequent analysis.

Denoising method can be filtering algorithm, smoothing algorithm, or determining outliers in state data based on statistical analysis algorithm or machine learning algorithm and eliminating them.

It should be noted that feature extraction can also be carried out on the state data of the qubit to extract meaningful features and eliminate redundant or irrelevant features, thus improving the monitoring efficiency and accuracy.

The specific process of feature extraction is to select the appropriate features according to the different physical parameters of the bridge. These features can be numerical features, spectral features, time domain features, etc; according to the nature of the data and the analysis target to choose; calculate the value of the selected feature based on the raw data. This may involve statistical calculations, signal processing techniques, mathematical modeling, etc.

With feature extraction, we are able to transform the data into a more compact, easy-to-understand form and extract information that is relevant to the analysis target. This can not only improve the efficiency of data processing and analysis, but also make the analysis results more intuitive and meaningful.

Further, for high-dimensional data, dimensionality reduction may be required to reduce the number of features and improve data processing efficiency and analysis speed. The extracted features are standardized to ensure comparability between different features. This helps to improve the accuracy of analysis results; For too many features, it may be necessary to select features that are more relevant to the analysis target to reduce redundant information. Based on practical problems, feature engineering is carried out to design new features or combination features to better reflect the nature of the data.

In summary, the bridge detection and monitoring method proposed by the implementation of the invention realizes high sensitivity and high resolution monitoring of the bridge structural state by utilizing the entanglement relationship of quantum bits. By preparing entangled states of qubits and deploying them at key locations in the bridge, it is possible to capture tiny structural changes in real time, thereby discovering and identifying potential anomalies in time. By monitoring changes in qubit state in real time, combined with data processing and analysis algorithms, detailed information on bridge structural changes can be obtained and converted into practical and useful monitoring data. This data can be used to predict structural health, identify anomalies, and guide maintenance and repair decisions. This method has significant advantages in the monitoring of subtle changes and remote locations that cannot be covered by traditional monitoring methods.

In addition, the implementation of the invention brings an innovative and forward-looking solution for the field of bridge structure health monitoring, which is not only of great significance in theory, but also has broad development prospects in practical application. This approach will play an important role in promoting the safety and sustainability of urban infrastructure, providing strong support for the construction and development of modern cities.

In order to better implement the bridge monitoring method in the implementation of the invention, on the basis of the bridge monitoring method, the implementation of the invention also provides a bridge monitoring system correspondingly, as shown in FIG. 7. The bridge monitoring system 700 comprises:
the qubit pair acquisition unit 701 is used to obtain at least one qubit pair in the quantum entangled state;
the coupling relationship building unit 702 is used to construct a coupling relationship between the qubit pair state of at least one qubit pair and the physical parameters of the bridge;
the bridge monitoring unit 703 is used to monitor the qubit pair state of at least one qubit pair, and the structural state of the bridge is determined based on the qubit pair state and the coupling relationship.

The bridge monitoring system 700 provided by the above implementations can realize the technical scheme described in the above implementations of the bridge monitoring method, and the principle of the specific realization of the above modules or units can be referred to the corresponding content in the above implementations of the bridge monitoring method, which will not be repeated here.

As shown in FIG. 8, the invention also correspondingly provides a structural condition monitoring device 800. The structural condition monitoring device 800 comprises a processor 801, a memory 802 and a display 803. FIG. 8 shows only some of the components of the structural condition monitoring device 800. It should be understood that it is not necessary to implement all of the components shown, and more or fewer components can be implemented instead.

The processor 801 may in some implementations be a Central Processing Unit (CPU), microprocessor, or other data processing chip used to run program code stored in memory 802 or to process data, such as the bridge monitoring method in the present invention.

In some implementations, the processor 801 can be a single server or a group of servers. Server groups can be centralized or distributed. In some implementations, the processor 801 might be local or remote. In some implementations, the processor 801 can be implemented on a cloud platform. In one implementation, the cloud platform may include private cloud, public cloud, hybrid cloud, community cloud, distributed cloud, on-premise, multiple cloud, or any combination of the above.

Memory 802 may in some implementations be an internal storage unit of a structural condition monitoring device 800, such as a hard disk or memory of a structural condition monitoring device 800. The memory 802 May also be an external storage device of the structural condition monitoring device 800 in other implementations, such as a plug-in hard disk equipped with the structural condition monitoring device 800, a Smart Media Card (SMC), a Secure Digital (SD) card, an external storage device. Flash Card, etc.

Further, the memory 802 May also include both an internal storage unit of a structural condition monitoring device 800 and an external storage device. The memory 802 is used to store application software and various types of data for the installation of the structural condition monitoring device 800.

The display 803 in some implementations can be an LED display, a liquid crystal display, a touch LCD display, and an OLED (Organic Light-Emitting Diode) touch device. The display 803 is used to display information in the structural condition monitoring device 800 and to display a visual user interface. The components of the structural condition monitoring device 800 (unit 801-803) communicate with each other through the system bus.

In some implementations of the invention, when the processor 801 executes the bridge monitoring program in memory 802, the following steps can be achieved:
obtaining at least one qubit pair in the quantum entangled state;
constructing a coupling relationship between the qubit pair state of at least one qubit pair and the physical parameters of the bridge;
monitoring the qubit pair state of at least one qubit pair, and the structural state of the bridge is determined based on the qubit pair state and the coupling relationship.

It should be understood that when the processor 801 executes the bridge monitoring program in memory 802, other functions can be implemented in addition to the above functions, which can be described in the previous implementation of the corresponding method.

Further, the implementation of the invention does not specify the type of the mentioned structural condition monitoring device 800, and the structural condition monitoring device 800 can be used for mobile phones, tablet computers, personal digital assistant, etc. PDA, wearable device, laptop and other portable structural condition monitoring devices. Exemplary implementations of portable structural condition monitoring devices include, but are not limited to, portable structural condition monitoring devices equipped with IOS, android, microsoft, or other operating systems. The portable structural condition monitoring device may also be other portable structural condition monitoring devices, such as a laptop with a touch-sensitive surface (such as a touch panel). It should also be understood that in some other implementations of the present invention, the structural condition monitoring device 800 May also not be a portable structural condition monitoring device, but a desktop computer with a touch-sensitive surface, such as a touch panel.

Accordingly, the present application implementation also provides a computer-readable storage medium for storing a computer-readable program or instruction that, when executed by the processor, is capable of realizing the steps or functions in the bridge monitoring method provided by the implementations of the above methods.

It is understood by those skilled in the art that all or part of the process to implement the above implementations may be accomplished by instructs the relevant hardware (e.g. processor, controller, etc.) through a computer program that may be stored in a computer readable storage medium. Among them, the computer readable storage medium is disk, optical disc, read-only storage memory or random storage memory.

The above bridge monitoring method, system, structure state monitoring equipment and storage medium provided by the invention are introduced in detail. The principle and implementation mode of the invention are described in this paper with specific examples. The above implementation is only used to help understand the method and its core idea of the invention. At the same time, for the technical personnel in the field, according to the idea of the invention, there will be changes in the specific mode of implementation and scope of application, in summary, the content of this specification should not be understood as a limitation of the invention.

What is claimed is:

1. A bridge monitoring method, comprising:
obtaining at least one qubit pair in the quantum entangled state;
constructing a coupling relationship between the qubit pair state of at least one qubit pair and the physical parameters of the bridge;
monitoring the qubit pair state of at least one qubit pair, and the structural state of the bridge is determined based on the qubit pair state and the coupling relationship.

2. The bridge monitoring method of claim 1, wherein obtaining at least one qubit pair in the quantum entangled state, comprising:
obtaining at least two initial qubits, the quantum gate operation is performed on the at least two initial qubits to obtain the at least one qubit pair in the quantum entanglement state.

3. The bridge monitoring method of claim 2, wherein at least two initial qubits comprise at least one initial qubit pair, and the quantum gate operation comprises controlled non-gate operation and hadamard gate operation; the quantum gate operation is performed on the at least two initial qubits to obtain the at least one qubit pair in the quantum entanglement state, comprising:
controlled non-gate operation is performed on the initial qubit pair to obtain an associated qubit pair, which comprises a first associated qubit and a second associated qubit.
hadamard gate operation is performed on the first associated qubit or the second associated qubit to obtain at least one qubit pair in a quantum entangled state.

4. The bridge monitoring method of claim 2, wherein the qubit pair comprises a first qubit and a second qubit; after obtaining at least one qubit pair in the quantum entangled state, comprising:
the correlation between the first qubit and the second qubit is measured, and the existence of the quantum entangled state is confirmed based on the correlation, when the quantum entangled state does not exist, the quantum gate operation is re-performed on the qubit pair.

5. The bridge monitoring method of claim 1, wherein comprising:
obtaining the reference structure state of the bridge, and determining whether the coupling relationship needs to be adjusted based on the reference structure state and the structure state;
when the coupling relationship needs to be adjusted, the qubit parameters of the qubit, and/or the positional parameters of the qubit are adjusted to obtain the optimization parameters, and the optimized coupling relationship is obtained according to the optimization parameters.

6. The bridge monitoring method of claim 1, wherein the qubit pair comprises a first qubit and a second qubit; the qubit pair state comprises the first qubit, and/or the quantum state of the second qubit and the quantum entangled state of the qubit pair, the coupling relation comprises a first coupling relation between the quantum state and the physical parameters of the bridge and a second coupling relation between the quantum entangled state and the physical parameters of the bridge; the qubit pair state of at least one qubit pair is monitored, comprising:
monitoring the quantum state of the first qubit and/or the second qubit and determine the structural state of the bridge based on the quantum state and the first coupling relationship;
and/or,
monitoring the quantum entangled state, and the structural state of the bridge is determined based on the quantum entangled state and the second coupling relation.

7. The bridge monitoring method of claim 1, wherein comprising:
obtaining the temporal and positional characteristics of the structural state;
the visualization template is determined based on the time feature and the position feature, and the structure state is visually displayed based on the visualization template.

8. A bridge monitoring system, comprising:
the qubit pair acquisition unit is used to obtain at least one qubit pair in the quantum entangled state;
the coupling relationship building unit is used to construct a coupling relationship between the qubit pair state of at least one qubit pair and the physical parameters of the bridge;
the bridge monitoring unit is used to monitor the qubit pair state of at least one qubit pair, and the structural state of the bridge is determined based on the qubit pair state and the coupling relationship.

9. A structure state monitoring device, comprising memory and processor, among which,
the memory is used to store a program;
the processor, coupled with the memory, is used to execute the program stored in the memory to implement the steps in the bridge monitoring method described in the claim 1.

10. A computer-readable storage medium is used to store a computer-readable program or instruction that, when executed by the processor, is capable of fulfilling the steps in the bridge monitoring method described in the claim 1.
